(19) United States
(12) Patent Application Publication
(10) Pub. No.: US 2018/0056496 A1
(43) Pub. Date: Mar. 1, 2018

(54) Modular Handheld Power Tool

(71) Applicants: Robert Bosch Tool Corporation, Broadview, IL (US); Robert Bosch GmbH, Stuttgart (DE)

(72) Inventors: Jeremy Rubens, Palatine, IL (US); Saad Alam, Franklin Park, IL (US)

(21) Appl. No.: 15/249,023

(22) Filed: Aug. 26, 2016

(51) Int. Cl. B25F 3/00; B23K 3/03; B23K 26/00; B44B 7/02; B05C 17/005; H02J 7/00

(52) U.S. Cl. CPC B25F 3/00; B23K 3/0323; H02J 7/0068; B44B 7/02; B05C 17/00526; B23K 26/0096

(57) ABSTRACT

A power tool system includes a base unit having a rechargeable lithium-ion battery, a battery charging system, a power control system and a power output connection. A plurality of head units is configured for use with the base unit. Each of the head units includes an electrical input connection. The electrical input connection is configured to be electrically connected to the power output connection when the head unit is attached to the base unit. Each of the head units is configured to use the electrical power provided by the base unit to perform a different tool function.

### TECHNICAL FIELD

This invention relates generally to the field of handheld power tools, and more particularly to handheld power tools having rechargeable lithium-ion batteries.

### BACKGROUND

Handheld power tools may be configured as corded tools which receive power via a cord which connects to a power source, such as an AC outlet. While the power cord provides a reliable source of power for the tool, the cord poses limits to the areas and operating range of the power tool. Cordless power tools are configured to receive power from a battery attached to the tool. Because the power source is part of the tool, cordless power tools provide portability and convenience advantages over corded tools.

Cordless power tools are typically provided with rechargeable batteries which can be recharged as needed when the batteries power has been depleted. One type of rechargeable battery which has achieved widespread use is lithium-ion based batteries. Lithium-ion cell batteries are typically lighter and have a much slower self-discharge rate than energy-equivalent batteries of other types. However, lithium-ion cell batteries can also be expensive. Lithium-ion cell batteries also require electronics for protecting the battery from being drained too much. The cost of the battery, charger and control electronics can cost more than 70% of the total cost of the power tool.

### BRIEF DESCRIPTION OF THE DRAWINGS

FIG. 1 is a schematic depiction of an embodiment of a modular handheld power tool in accordance with the present disclosure with the head unit attached to the base unit.

FIG. 2 depicts the modular handheld power tool of FIG. 1 with the head unit detached from the base unit.

FIG. 3 depicts an alternative embodiment of the head unit of the modular handheld power tool of FIG. 1 that comprises a rotary tool head unit.

FIG. 4 depicts an alternative embodiment of the head unit of the modular handheld power tool of FIG. 1 that comprises an oscillating tool head unit.

FIG. 5 depicts an alternative embodiment of the head unit of the modular handheld power tool of FIG. 1 that comprises an reciprocating tool head unit.

FIG. 6 depicts an alternative embodiment of the head unit of the modular handheld power tool of FIG. 1 that comprises a circular saw head unit.

FIG. 7 depicts an alternative embodiment the head unit of the modular handheld power tool of FIG. 1 that utilizes only electrical power provided by the base unit.

FIG. 8 depicts an alternative embodiment of the head unit of FIG. 8 that comprises a flash light head unit.

FIG. 9 depicts an alternative embodiment of the head unit of FIG. 8 that comprises a glue gun head unit.

FIG. 10 depicts the base unit of the modular handheld power tool of FIG. 1 being used to supply power to an external component.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one of ordinary skill in the art to which this invention pertains.

The present disclosure is directed to a modular handheld power tool and power tool system that enables certain tool components, such as a mechanical drive system and power source, e.g., rechargeable battery, to be provided as a stand-alone device which can be equipped with different head units that can be coupled to the mechanical and/or electrical power of the base unit to perform different functions. Thus, the same battery and mechanical drive system can be used to power multiple tools. Because the same battery and mechanical drive system is used for multiple tools, the expense to a consumer of having multiple tools for performing different tasks can be significantly reduced.

In accordance with the present disclosure, a power tool is provided with a modular configuration in which the battery, charger, and power control system are provided as a separate unit, referred to herein as a base unit, to which different tool head units can be attached and swapped out as needed. The base unit provides the power to the head unit and also includes the battery monitoring and battery discharge control functionality that is required to maintain the battery, such as a rechargeable, lithium-ion battery, in good working order and to maximize the life of the battery.

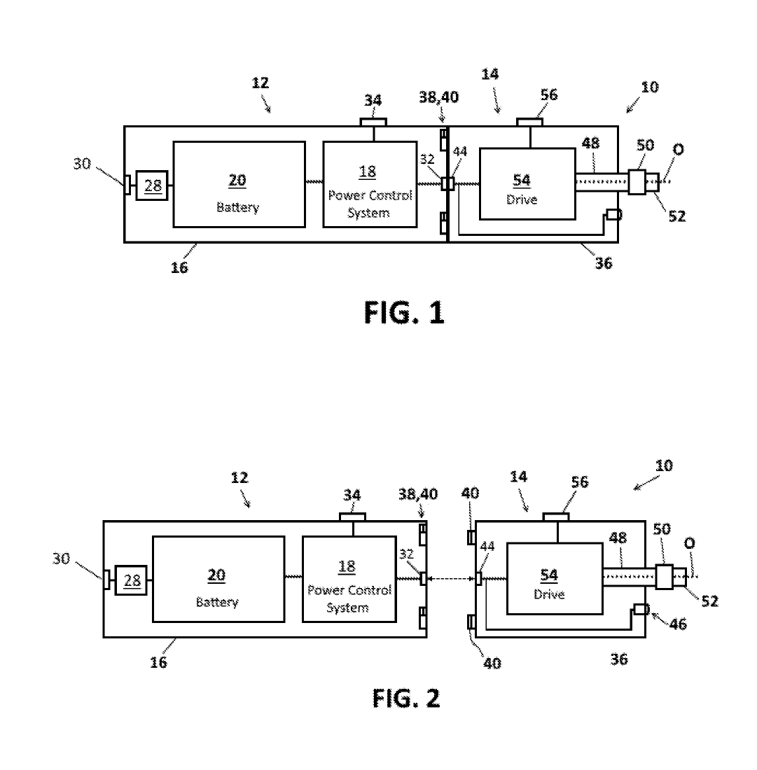

FIGS. 1 and 2 depict an embodiment of a modular handheld power tool 10 in accordance with the present disclosure. As depicted, the power tool 10 comprises a base unit 12 and a head unit 14. The base unit 12 includes a housing 16 that encloses a power control system 18 and an energy storage unit 20. The housing 16 may be formed of a rigid material such as plastic, metal, or composite materials such as a fiber reinforced polymer. In one embodiment, the housing 16 has a generally cylindrical shape to enable the housing to be used as a grip or handle for holding and manipulating the tool. In alternative embodiments, the housing 16 may be provided in a variety of shapes and sizes and may include other features, such as handles and grips which extend outwardly from the base unit.

The energy storage unit 20 comprises a rechargeable lithium-ion cell battery. The battery may be removable from the housing or integrated into the housing. The rechargeable battery is configured to produce an output voltage that is capable of powering the head unit, such as 3.6V, 7.2V, 9.6V, 12V, 14.4V, 18V, or 24V although any suitable battery voltage may be used.

A battery charging system 28 is configured to recharge the rechargeable battery 20. The battery charging system 28 is coupled to the rechargeable battery 20 to supply energy to the battery in order to recharge the battery. The charging system 28 may receive power from an external source via a charging connection 30. Any suitable type of connection may be used.

The power control system 18 is configured to control the supply of power from the battery 20 to the head unit and to monitor the voltage and/or current level of the rechargeable battery 20 to prevent over discharging and overheating of the battery. The power control system is configured to cut off the supply of power to the head unit when the battery voltage level reaches a predetermined minimum value and when the battery temperature reaches a predetermined maximum value. The power control system is also configured to control the discharge rate or current draw of the battery. The power control system may be configured to monitor and/or control any function of the battery that is needed to maintain the battery in good working condition.

The power control system supplies power to the head unit via an electrical power output connection 32. Any suitable type of connection may be used for the power output connection 32. The base unit also includes an operator control element 34, such as a pushbutton, slide switch, or the like, for controlling indicating when the operator desires for power to be supplied to the head unit.

The head unit 14 of the modular power tool 10 includes a housing 36 which encloses tool components which are configured to provide the functionality for the head unit. The housing 36 may be formed of a rigid material such as plastic, metal, or composite materials such as a fiber reinforced polymer, and has any suitable shape for enclosing and facilitating the functionality provided by the head unit.

The head unit 14 is configured to be quickly and easily installed and removed from the base unit 12 of the tool so that different head units that provide different tool functions can be swapped in and out as needed. In one embodiment, to enable the head unit 14 to be quickly installed and removed from the base unit 12, the head unit and the base unit are provided with mating attachment structures 38, 40 which enable the head unit 14 to be secured to the base unit 12 without the use of fasteners, such as screws or bolts. The attachment structures 38, 40 may be configured to provide a snap fit connection, twist lock connection, and the like. For example, the head unit may be provided with detents, slots, prongs, or the like which are configured to be interact with complementarily configured detents, slots, prongs, or the like provided on the base unit.

In the embodiment of FIG. 1, the head unit 14 is configured to receive and utilize electrical power provided by the base unit 12. To this end, the head unit 14 includes an electrical power input connection 44 which is configured to be electrically connected to the power output connection 32 of the base unit 12 when the head unit 14 is attached to the base unit 12.

The head unit 14 includes a tool output component which is configured to receive mechanical or electrical power from the base unit to perform a tool function. The tool function can be any of a variety of different functions which may be implemented in a head unit, examples of which are included below. The head unit 14 of FIG. 1 is configured as a driver head unit which implements a driver functionality. The drive head unit includes an output shaft 48 that is configured to be coupled to the input drive shaft 42 so that rotation of the input drive shaft 42 can impart a drive motion to the output shaft 48. The output shaft 48 extends from the housing 36 of the head unit and includes a tool holder 50. The tool holder 50 is configured to retain a tool bit 52, such as flat head bit, Philips head bit, hex head bits, and the like. The tool holder 50 rotates with the output shaft 48 which in turn rotates the tool bit 52 to perform work. In alternative embodiments, the tool holder 50 may comprise a drill chuck or collet for retaining the shank of a rotary accessory tool, such a drill bit, sanding or grinding disc, and the like, so the accessory tool can be rotated to perform work on workpieces.

The drive 54 may include a transmission (not shown) for converting the rotary motion of the input drive shaft 42 (as provided by the drive shaft of the base unit) to a suitable motion for driving the output shaft 48. For example, the transmission may include one or more gears, clutches, drive shafts, and the like (not shown) for altering the speed and/or torque provided by the drive system 54. The transmission may be configured to alter the drive axis so that it is transverse to the axis of rotation of the drive system. The transmission may also be configured to convert the rotary motion to another type of drive motion for the head unit, such as oscillating, orbiting, and/or reciprocating.

The head unit 14 is configured to utilize electrical power received from the base unit 12 to power electrical components, such as light 46. The electrical power from the base unit 12 may also be used to power sensors, control systems, and drive systems (not shown) which may be incorporated into the head unit to add, facilitate and/or enhance functionality of the head unit. The head unit 14 may also include operator control elements 56, such as buttons and switches, for controlling the electrical and/or mechanical components of the head unit.

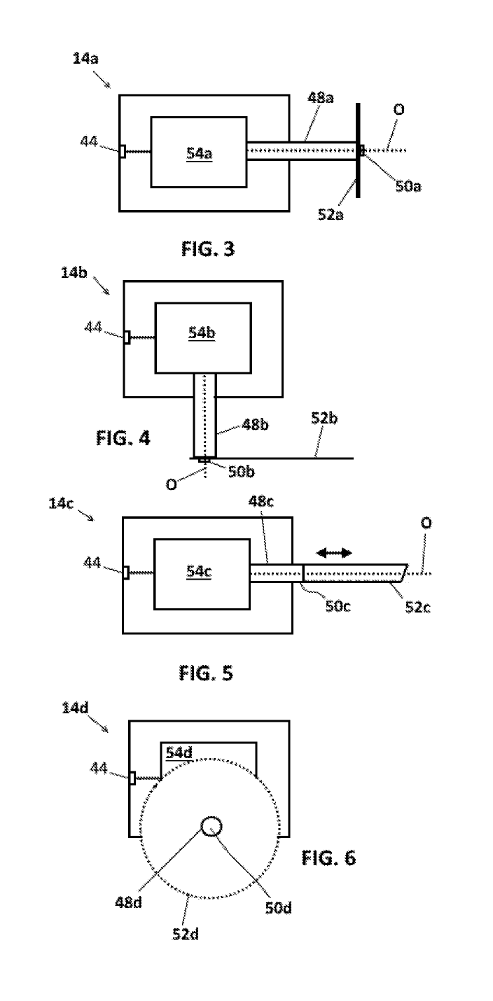

FIGS. 3-6 depict different embodiments of head units 14a, 14b, 14c, 14d which may be used with and swapped onto the base unit 12 of the power tool of FIG. 1 as needed. The head unit 14a of FIG. 3 comprises a rotary tool head unit. The rotary tool head unit has an output shaft 42 with a tool holder 50 that is configured to retain rotary tool accessories 52a, such as sanding or grinding discs, cutting discs. The drive 54 is configured to provide a rotational drive motion at a suitable speed for driving the accessory tools to perform work.

The head unit 14b of the embodiment of FIG. 4 comprises an oscillating tool head unit. In this embodiment, the drive 54b is configured provide an oscillating drive motion that oscillates the output shaft 48 about an oscillation axis O at an appropriate speed. The output shaft 48b is arranged substantially perpendicular to the drive axis of the base unit. The tool holder 50 is configured to retain an oscillating accessory tool 52b, such as a cutting blade, so that it is oscillated with the output shaft.

FIG. 5 depicts a reciprocating tool head unit 14c. In this embodiment, the drive 54c is configured to impart a reciprocating drive motion which results in the output shaft 48c being reciprocated along the output axis O. In this embodiment, the tool holder 50c is configured to retain a tool 52c, such as a reciprocating saw blade or jig saw blade, which is reciprocated to perform work on a workpiece. The head unit 14d of FIG. 6 comprises a circular saw head unit. The tool holder 50d is configured to retain a circular saw blade 52d that is rotated about the output axis O by the output shaft.

Referring to FIG. 7, a head unit 14e includes a drive system 58 and a tool output component 60. The drive system 58 is configured to receive electrical power via the electrical input connection 44 of the head unit 14e and is configured to utilize the electrical power to actuate the tool output component 60 to perform a function. In one embodiment, the tool output component 60 comprises a soldering iron. In this embodiment, the drive system is configured to use the electrical energy provided by the base unit to heat the tool output component. In other embodiments, the tool output component 60 may comprise a wood burning implement which may be heated by the drive system. In another alternative embodiment, the tool output component 60 may comprise a laser engraver which is configured to be energized by the drive system.

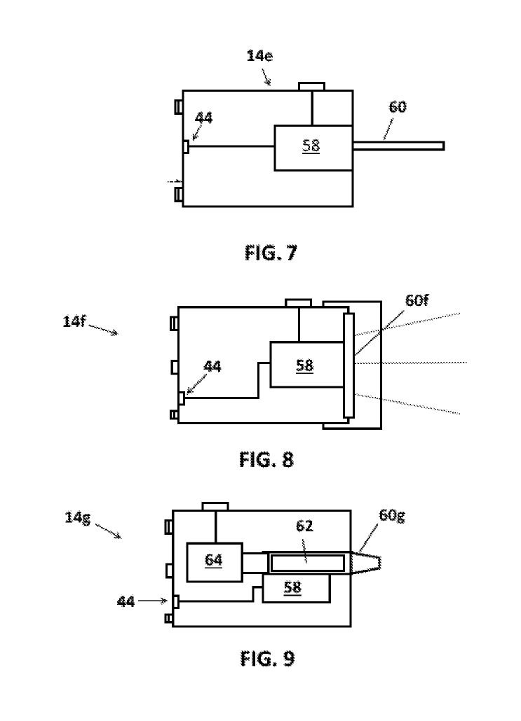

FIG. 8 depicts another embodiment of a head unit 14f that is configured to utilize only the electrical power provided by the base unit 12. In the embodiment of FIG. 8, the head unit 14f comprises a flash light head unit. In this embodiment, the tool output component 60f comprises a lighting system including one or more light generating devices, such as light bulbs, LEDs, and the like, which is configured to receive power from the drive system.

FIG. 9 depicts an embodiment of a head unit 14g that comprises a glue gun head unit. In this embodiment, the head unit 14g includes a drive system 58 which is configured to generate heat for melting a glue stick 62. The glue stick may be inserted into the head unit in any suitable manner. The head unit may also include a mechanical and/or electrical actuation system 64 which enables the glue stick to be advanced toward an output nozzle 60g so that melted glue can be expelled from the head unit in a suitable manner.

Although not depicted in the drawings, various other types of head units may be implemented which perform a variety of other functions. For example, head units may be configured as vacuum head units which can attached to the base unit and powered to serve as a portable vacuum. A head unit may also be configured as a blower head unit which can be powered by the base unit to output an air flow which can be used for various tasks as needed. Substantially any type of head unit may be implemented which can receive mechanical and/or electrical power provided by the base unit to function.

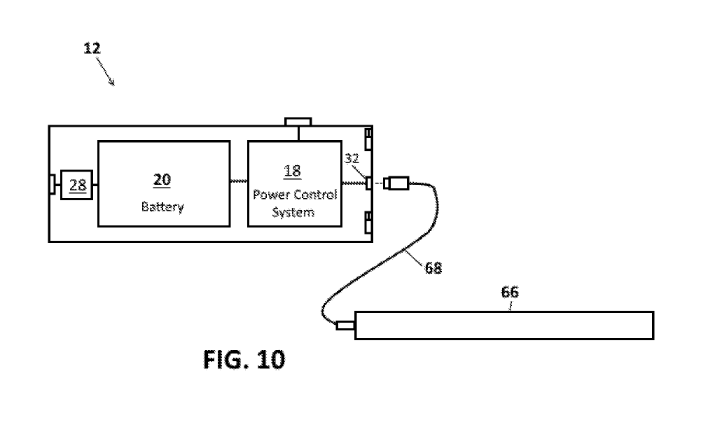

The base unit 12 may also be used without an attached head unit. For example, the base unit 12 may be used to supply electrical energy to other components which need not be attached to the base unit. The electrical energy provided by the base unit 12 may be used to charge electrical components, such as a mobile phone or tablet 66, as depicted in FIG. 10. The electrical energy may also be used to power electrical components, such as radios, phones, tablets, and the like. To this end, the electrical output connection 32 of the base unit, or another power output connection provided on the base unit, may be configured to connect to a connector of a power/charging cable 68.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A power tool system comprising:
a base unit including:
a main housing including a first attachment structure;
a rechargeable lithium-ion battery enclosed in the main housing;
a charging system enclosed in the main housing coupled to the battery and to a power input port, the charging system being configured to charge the battery using power supplied via the power input port;
a power control system enclosed in the main housing, the power control system being coupled to the battery and being configured to supply power from the battery to a power output connection, the power control system being configured to monitor a voltage level of the battery and to cut off power to the power output connection when the voltage level of the battery reaches a predetermined minimum value;
a plurality of head units, each of the head units including:
a head housing including a second attachment structure, the second attachment structure being configured to be removably attached to the first attachment structure;
a power input connection configured to connect to the power output connection and to receive power via the power input connection;
a drive system enclosed in the head housing and coupled to receive power via the power input connection;
a tool component configured to be driven by the drive system to perform a tool function;
wherein the tool function performed by each of the head units in the plurality is different.

2. The power tool system of claim 1, wherein the drive system of at least one of the plurality of head units comprises a rotary drive system.

3. The power tool system of claim 2, wherein the drive system of at least one of the plurality of head units comprises an oscillating drive system.

4. The power tool system of claim 3, wherein the drive system of at least one of the plurality of head units comprises a reciprocating drive system.

5. The power tool system of claim 1, wherein the tool drive component comprises one of a soldering gun, a laser engraver, a wood burner, and a glue gun.

6. The power tool system of claim 1, wherein the first attachment structure and the second attachment structure are configured to have a snap fit connection.

7. The power tool system of claim 1, wherein the first attachment structure and the second attachment structure are configured to have a twist lock connection.

8. A power tool comprising:
a base unit including:
a main housing including a first attachment structure;
a rechargeable lithium-ion battery enclosed in the main housing;
a charging system enclosed in the main housing coupled to the battery and to a power input port, the charging system being configured to charge the battery using power supplied via the power input port;
a power control system enclosed in the main housing, the power control system being coupled to the battery and being configured to supply power from the battery to a power output connection, the power control system being configured to monitor a voltage level of the battery and to cut off power to the power output connection when the voltage level of the battery reaches a predetermined minimum value;
a head units including:
a head housing including a second attachment structure, the second attachment structure being configured to be removably attached to the first attachment structure;
a power input connection configured to connect to the power output connection and to receive power via the power input connection;
a drive system enclosed in the head housing and coupled to receive power via the power input connection;
a tool component configured to be driven by the drive system.

9. The power tool of claim 8, wherein the drive system comprises a rotary drive system.

10. The power tool system of claim 8, wherein the drive system comprises an oscillating drive system.

11. The power tool system of claim 8, wherein the drive system comprises a reciprocating drive system.

12. The power tool of claim 8, wherein the tool drive component comprises one of a soldering gun, a laser engraver, a wood burner, and a glue gun.

13. The power tool system of claim 8, wherein the first attachment structure and the second attachment structure are configured to have a snap fit connection.

14. The power tool system of claim 8, wherein the first attachment structure and the second attachment structure are configured to have a twist lock connection.
